(19) United States
(12) Patent Application Publication
(10) Pub. No.: US 2023/0153545 A1
(43) Pub. Date: May 18, 2023

(54) METHOD FOR CREATING RULES USED TO STRUCTURE UNSTRUCTURED DATA

(71) Applicant: MISOINFO Tech., Seoul (KR)

(72) Inventors: Dong Uk An, Seoul (KR); Su-young Ho, Seoul (KR); Sang-do Nam, Seoul (KR); Jin-ho Son, Hanam-si (KR); Kwang-jae Won, Suwon-si (KR)

(21) Appl. No.: 17/986,793

(22) Filed: Nov. 14, 2022

(30) Foreign Application Priority Data
Nov. 15, 2021 (KR) 10-2021-0156462

(51) Int. Cl. G06F 40/56; G06F 40/247; G06F 40/242

(52) U.S. Cl. CPC G06F 40/56; G06F 40/247; G06F 40/242

(57) ABSTRACT

Disclosed is a method for creating rules used to structure unstructured data, which is performed by a computing device including at least one processor, according to some aspects of the present disclosure. The method may include: creating analysis data by performing pre-processing on raw data; and providing at least one rule used to perform data structuring by analyzing the analysis data using a network model.

### CROSS REFERENCE TO RELATED APPLICATION

The present application claims priority to Korean Patent Application No. 10-2021-0156462, filed on Nov. 15, 2021, the entire contents of which is incorporated herein for all purposes by this reference.

### BACKGROUND

### 1. Field

One aspect of the present disclosure relates to a method for creating rules used to structure unstructured data.

### 2. Description of related art

In a hospital, doctors input medical records not based on preset rules. Thus, there are many cases where medical record data are unstructured data. In order to analyze data using unstructured data like the medical record data, work of structuring unstructured data is necessarily required.

Conventionally, unstructured data in the hospital have been manually processed to make structured data. However, it may require a lot of time and human assistance to manually process and structure the unstructured data in the hospital. In addition, when a person directly performs data structuring, a probability of an error occurring during the data structuring may be increased. Therefore, there is a demand for a method to automatically create rules that may be used to structure the unstructured data in the hospital.

### RELATED ART DOCUMENT

### Patent Document

(Patent Document 0001) Korean Registered Patent No. 10-2297480

### SUMMARY

One aspect of the present disclosure has been devised in response to the above background art, and provides a method for creating rules that may be used to structure unstructured data using a computing device.

The technical objects of the present disclosure are not limited to the technical objects mentioned above, and other technical objects not mentioned will be clearly understood by those skilled in the art from the following description.

In order to achieve the above objects, some aspects of the present disclosure disclose a method for creating rules used to structure unstructured data, which is performed by a computing device including at least one processor. The method may include: creating analysis data by performing pre-processing on raw data; and providing at least one rule used to perform data structuring by analyzing the analysis data using a network model.

In addition, the creating of the analysis data by performing the pre-processing on the raw data may include combining text data included in mutually different categories.

In addition, the creating of the analysis data by performing the pre-processing on the raw data may include converting specific character data included in the raw data into preset character data.

In addition, the creating of the analysis data by performing the pre-processing on the raw data may include creating the analysis data by extracting text data to be analyzed among text data included in the raw data.

In addition, the providing of the at least one rule used to perform the data structuring by analyzing the analysis data using the network model may include: receiving classification system information, thesaurus data, and dictionary data; and creating the at least one rule by inputting the classification system information, the thesaurus data, the dictionary data, and the analysis data into an analysis model trained using learning data corresponding to a domain determined based on the classification system information, the thesaurus data, and the dictionary data.

In addition, the classification system information may include information that is created as a manager who has expert knowledge in the domain inputs at least one data corresponding to each of a plurality of hierarchically configured levels, the thesaurus data may be created as the manager inputs data having a similar meaning to the at least one data included in the classification system information, and the dictionary data may be created as the manager inputs a lexical meaning of the at least one data included in the classification system information.

In addition, the at least one rule may include at least one of a rule related to a distance between keywords included in the analysis data and a rule related to an order relation between the keywords included in the analysis data.

The method may further include converting structured data based on a predefined code table, when the unstructured data is converted into the structured data based on any one of the at least one rule.

In addition, the predefined code table may be a table in which code values are mapped to each of data classified as a plurality of levels in classification system information.

The technical solutions obtainable in the present disclosure are not limited to the above-mentioned technical solutions, and other technical solutions not mentioned will be clearly understood by those skilled in the art to which the present disclosure belongs from the description below.

One aspect of the present disclosure can increase convenience when structuring data by creating and providing rules that may be used to structure unstructured data by the computing device.

The effects obtainable in the present disclosure are not limited to the above-mentioned effects, and other effects not mentioned will be clearly understood by those skilled in the art to which the present disclosure belongs from the description below.

### BRIEF DESCRIPTION OF DRAWINGS

Various aspects are now described with reference to the drawings, wherein like reference numerals are used to refer to like elements collectively. In the following aspects, for the purpose of explanation, numerous specific details are set forth in order to provide a thorough understanding of one or more aspects. However, it will be appreciated that such aspect(s) may be practiced without the specific details.

FIG. 1 is a block diagram of a computing device that creates rules used to structure unstructured data according to some aspects of the present disclosure.

FIG. 2 is a flowchart for illustrating an example of a method for providing at least one rule used to structure unstructured data by the computing device according to some aspects of the present disclosure.

FIG. 3 is a diagram for illustrating an example of a method for creating analysis data by performing pre-processing on the unstructured data by the computing device according to some aspects of the present disclosure.

FIG. 4 is a diagram for illustrating an example of classification system information according to some aspects of the present disclosure.

FIG. 5 is a diagram for illustrating an example of at least one created rule according to some aspects of the present disclosure.

FIG. 6 is a diagram for illustrating an example of a method for post-processing data according to some aspects of the present disclosure.

FIG. 7 illustrates a simplified general schematic diagram for an exemplary computing environment in which some aspects of the present disclosure may be implemented.

### DETAILED DESCRIPTION

Various aspects are now disclosed with reference to the drawings. In the following description, numerous specific details are set forth to provide a thorough understanding of the present disclosure. However, it will also be appreciated that such aspects may be practiced without these specific details.

The terms “component,” “module,” “system,” and the like, as used herein, refer to a computer-related entity, hardware, firmware, software, a combination of software and hardware, or execution of software. For example, a component can be, but is not limited thereto, a procedure executed in a processor, a processor, an entity, a thread of execution, a program, and/or a computer. For example, both an application executed in a computing device and the computing device may be a component. One or more components may reside within a processor and/or thread of execution. One component may be localized within one computer. One component may be distributed between two or more computers. In addition, these components can be executed from various computer readable media having various data structures stored therein. For example, components may communicate via local and/or remote processes according to a signal having one or more data packets (for example, data from one component interacting with another component in a local system and a distributed system, and/or data transmitted via another system and a network such as an Internet through a signal).

In addition, the term “or” is intended to mean inclusive “or”, not exclusive “or”. In other words, unless otherwise specified or if unclear in context, the expression “X uses A or B” is intended to mean one of the natural inclusive substitutions. In other words, when X uses A; X uses B; or X uses both A and B, the expression “X uses A or B” can be applied to either of these cases. It is also to be understood that the term “and/or” used herein refers to and includes all possible combinations of one or more of the listed related items.

In addition, the terms “comprises” and/or “comprising” indicate the presence of corresponding features and/or elements. However, the terms “comprises” and/or “comprising” do not exclude the presence or addition of one or more other features, components, and/or groups thereof. Further, unless otherwise specified or unless it is clear from the context to refer to a singular form, the singular in the specification and claims may generally be construed to refer to “one or more”.

Further, the term “at least one of A or B” has to be interpreted to refer to “including only A”, “including only B”, and “a combination of configurations of A and B”.

Those skilled in the art will further appreciate that the various illustrative logical blocks, configurations, modules, circuits, devices, logics, and algorithm steps described in connection with the aspects disclosed herein may be implemented in electronic hardware, computer software, or combinations of both. To clearly illustrate this interchangeability of hardware and software, various illustrative components, blocks, configurations, devices, logics, modules, circuits, and steps have been described above generally in terms of their functionality. Whether such functionality is implemented as hardware or software depends upon the specific application and design restrictions imposed on the overall system. Those skilled in the art may implement the described functionality in various ways for each specific application. However, such implementation decisions may not be interpreted as a departure from the scope of the present disclosure.

The description of the presented aspects is provided to enable any person skilled in the art to make or use the present disclosure. Various modifications to these aspects will be readily apparent to those skilled in the art. The generic principles defined herein may be applied to other aspects without departing from the scope of the present disclosure. Thus, the present disclosure is not intended to be limited to the aspects presented herein. However, the present disclosure is to be construed in the widest scope consistent with the principles and novel features presented herein.

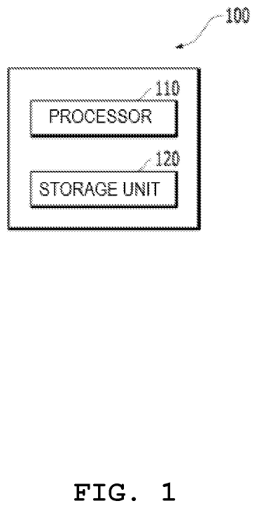

FIG. 1 is a block diagram of a computing device that creates rules used to structure unstructured data according to some aspects of the present disclosure.

The configuration of the computing device 100 shown in FIG. 1 is only a simplified example. In one aspect of the present disclosure, the computing device 100 may include other components for performing the computing environment of the computing device 100, and only some of the disclosed components may configure the computing device 100.

For example, the computing device 100 may include any type of computer system or computer device, such as a microprocessor, a mainframe computer, a digital processor, a portable device or a device controller.

The computing device 100 may include a processor 110 and a storage unit 120. However, the above-described components are not essential in implementing the computing device 100, and thus the computing device 100 may have more or fewer components than those listed above.

The processor 110 may consist of one or more cores, and may include a processor for data analysis and deep learning of a central processing unit (CPU) of a computing device, a general purpose graphics processing unit (GPGPU), a tensor processing unit (TPU), and the like. The processor 110 may read a computer program stored in the memory 130 and perform data processing for machine learning according to some aspects of the present disclosure. According to some aspects of the present disclosure, the processor 110 may perform an operation for learning the neural network. The processor 110 may perform the calculation for learning the neural network, such as processing input data for learning in deep learning (DL), extracting features from input data, calculating an error, and updating the weight of the neural network using backpropagation. At least one of a CPU, a GPGPU, and a TPU of the processor 110 may process the learning of a network function. For example, the CPU and the GPGPU together can process the learning of a network function and data classification using the network function. Further, in one aspect of the present disclosure, learning of a network function and data classification using the network function may be processed by using the processors of a plurality of computing devices together. In addition, the computer program executed in the computing device according to one aspect of the present disclosure may be a CPU, GPGPU or TPU executable program.

Meanwhile, throughout the present specification, a computation model, a nerve network, a network function, and the neural network may be used as an interchangeable meaning. That is, the computation model, the (artificial) neural network, the network function, and the neural network may be used as an interchangeable meaning. Hereinafter, for convenience of explanation, the computation model, the (artificial) neural network, the network function, and the neural network will be collectively described as a neural network.

The neural network may be composed of a set of interconnected calculation units, which may generally be referred to as nodes. These nodes may also be referred to as neurons. The neural network is configured to include at least one or more nodes. Nodes (or neurons) constituting the neural network may be interconnected by one or more links.

In the neural network, one or more nodes connected through a link may relatively form a relationship between an input node and an output node. The concept of the input node and the output node is relative, and any node serving as an output node with respect to one node may serve as an input node with respect to another node, and vice versa. As described above, an input node-to-output node relationship may be created about a link. One or more output nodes may be connected to one input node through a link, and vice versa.

In the relationship between the input node and the output node connected to each other through one link, the value of the data of the output node may be determined based on data input to the input node. A link that interconnects the input node and the output node may have a weight. The weight may be variable, and may be changed by the user or algorithm in order to allow the neural network to perform a desired function. For example, when one or more input nodes are interconnected to one output node by respective links, the output node may determine the output node value based on the values input to the input nodes connected to the output node and the weight assigned to the links corresponding to the respective input nodes.

As described above, one or more nodes are interconnected through one or more links in the neural network, thereby forming the relationship between the input node and an output node in the neural network. The characteristics of the neural network may be determined according to the number of nodes and links in the neural network, the correlation between the nodes and the links, and the value of a weight assigned to each of the links. For example, when there are two neural networks including the same number of nodes and links and having different weight values of the links, the two neural networks may be recognized as they are different from each other.

The neural network may consist of a set of one or more nodes. A subset of nodes constituting the neural network may constitute a layer. Some of the nodes constituting the neural network may configure one layer based on distances from the initial input node. For example, a set of nodes having a distance n from the initial input node may constitute n layers. The distance from the initial input node may be defined by the minimum number of links required to pass therethrough to reach the corresponding node from the initial input node. However, the definition of such a layer is arbitrary for description, and the order of the layer in the neural network may be defined in a different way from the above. For example, a layer of nodes may be defined by a distance from the final output node.

The initial input node may refer to one or more nodes to which data is directly input without going through a link in a relationship with other nodes among nodes in the neural network. Alternatively, in a relationship between nodes based on a link in a neural network, it may mean nodes that do not have other input nodes connected by a link. Similarly, the final output node may refer to one or more nodes that do not have an output node in a relationship with other nodes among nodes in the neural network. In addition, a hidden node may mean nodes constituting the neural network other than the first input node and the final output node.

The neural network according to one aspect of the present disclosure may be a neural network in which the number of nodes in the input layer may be the same as the number of nodes in the output layer, and the number of nodes decreases and then increases again from the input layer to the hidden layer. In addition, the neural network according to another aspect of the present disclosure may be a neural network in which the number of nodes in the input layer may be less than the number of nodes in the output layer, and the number of nodes decreases from the input layer to the hidden layer. In addition, the neural network according to another aspect of the present disclosure may be a neural network in which the number of nodes in the input layer may be greater than the number of nodes in the output layer, and the number of nodes increases from the input layer to the hidden layer. The neural network according to another aspect of the present disclosure may be a neural network which is a combination of the aforementioned neural networks.

The deep neural network (DNN) may refer to a neural network including a plurality of hidden layers in addition to an input layer and an output layer. The deep neural network can be used to identify the latent structures of data. In other words, it can identify the potential structure of photos, texts, videos, voices, and music (e.g., what objects are in the photos, what the text and emotions are, what the texts and emotions are, etc.). The deep neural network may include a convolution neural network (CNN), a recurrent neural network (RNN), an auto encoder, a generative adversarial network (GAN), and a restricted Boltzmann machine (RBM), a deep belief network (DBN), a Q network, a U network, a Siamese network, and a generative adversarial network (GAN). The above description of the deep neural network is only an example, and the present disclosure is not limited thereto.

The neural network may be trained using at least one of supervised learning, unsupervised learning, semi-supervised learning, and reinforcement learning. The training of the neural network may be a process of applying knowledge, which allows the neural network to perform a specific operation, to the neural network.

The neural network may be trained in a way that minimizes output errors. The training for the neural network refers to the process of iteratively inputting the learning data into the neural network, calculating the output of the neural network and the target error for the learning data, and updating the weight of each node of the neural network by back-propagating the error of the neural network from the output layer of the neural network to the input layer in the direction to reduce the error. In the case of supervised learning, learning data in which the correct answer is labeled in each learning data is used (that is, labeled learning data), and in the case of unsupervised learning, the correct answer may not be labeled in each learning data. That is, for example, learning data in the case of supervised learning regarding data classification may be data in which categories are labeled for each of the learning data. Labeled learning data is input to the neural network, and an error can be calculated by comparing the output (category) of the neural network with the label of the learning data. As another example, in the case of unsupervised learning regarding data classification, an error may be calculated by comparing the input learning data with the neural network output. The calculated error is back propagated in the reverse direction (that is, from the output layer to the input layer) in the neural network, and the connection weight of each node of each layer in the neural network may be updated according to the back propagation. A change amount of the connection weight of each node to be updated may be determined according to a learning rate. The calculation of the neural network on the input data and the backpropagation of errors may constitute a learning cycle (epoch). The learning rate may be applied differently depending on the number of repetitions of the learning cycle of the neural network. For example, in the early stage of learning of a neural network, a high learning rate can be used to enable the neural network to quickly acquire a certain level of performance, thereby increasing efficiency, and a low learning rate can be used at the end of learning to increase the accuracy.

In the learning of the neural network, in general, the learning data may be a subset of real data (that is, data to be processed using the learned neural network), and thus there is a learning cycle in which the error on the learning data is reduced, but the error on the real data is increased. Overfitting refers to a phenomenon in which errors on actual data increase by over-learning on learning data as described above. An example of the overfitting is a phenomenon in which a neural network that has learned a cat by seeing a yellow cat does not recognize a cat when it sees a cat having a color other than yellow. The overfitting may act as a cause of increasing errors in machine learning algorithms. In order to prevent such overfitting, various optimization methods can be used. In order to prevent the overfitting, methods such as increasing the learning data, regularization, dropout for deactivating some of the nodes of the network in the process of learning, and the use of a batch normalization layer can be applied.

According to some aspects of the present disclosure, the processor 110 may create analysis data by performing pre-processing on raw data.

For example, the processor 110 may perform pre-processing by a method for combining text data included in mutually different categories of the raw data.

For another example, the processor 110 may perform pre-processing by a method for converting specific character data included in the raw data into preset character data.

For still another example, the processor 110 may perform pre-processing by a method for extracting text data to be analyzed among text data included in the raw data.

The above-described examples are only examples, and the present disclosure is not limited to the above-described examples, and various pre-processing methods may be used to perform the pre-processing.

According to some aspects of the present disclosure, the storage unit 120 may store any type of information created or determined by the processor 110 and any type of information received by a network unit.

The storage unit 120 may include at least one type of storage media including a flash type memory, a hard disk type memory, a multimedia card micro type memory, a card type memory (for example, SD or XD memory, etc.), a random access memory (RAM). a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in relation to a web storage that performs a storage function of the storage unit 120 on the Internet. The description of the above storage unit 120 is only an example, and the present disclosure is not limited thereto.

According to some aspects of the present disclosure, the storage unit 120 may store a network model.

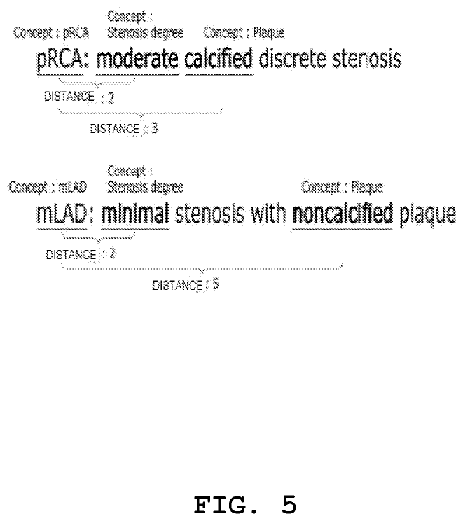

For example, the storage unit 120 may store a network model for creating at least one rule used to analyze and structure the analysis data. The detailed description thereof will be described with reference to FIG. 5.

According to software implementation, aspects such as procedures and functions described in the present specification may be implemented as separated software modules. Each of the software modules may perform one or more functions and operations described in the present specification. A software code may be implemented as a software application written in appropriate programming language. The software code may be stored in the storage unit 120 of the computing device 100 and executed by the processor 110 of the computing device 100.

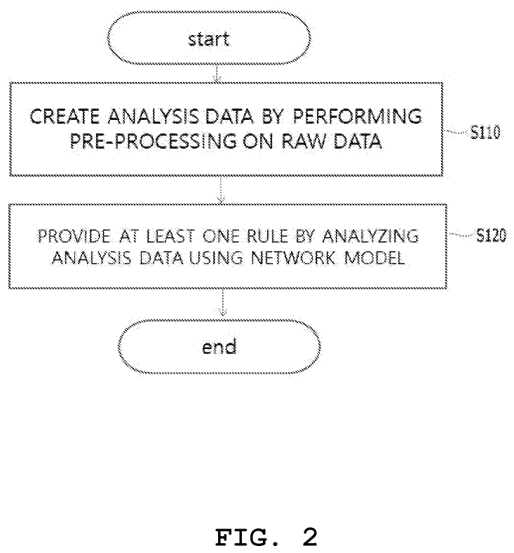

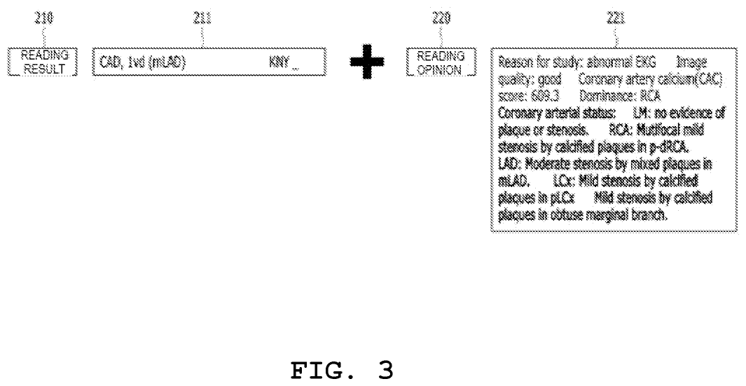

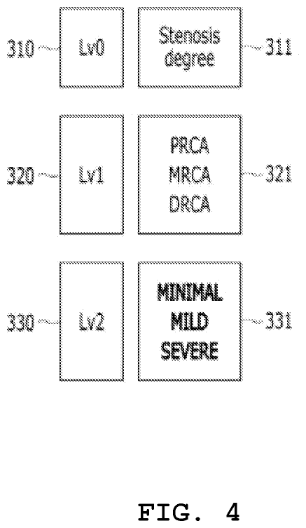

FIG. 2 is a flowchart for illustrating an example of a method for providing at least one rule used to structure unstructured data by the computing device according to some aspects of the present disclosure. FIG. 3 is a diagram for illustrating an example of a method for creating analysis data by performing pre-processing on the unstructured data by the computing device according to some aspects of the present disclosure. FIG. 4 is a diagram for illustrating an example of taxonomy information according to some aspects of the present disclosure.

With reference to FIG. 2, the processor 110 may create analysis data by performing pre-processing on raw data (S110). In this case, the raw data may be medical record data recorded by medical staffs. However, the present disclosure is not limited thereto.

Meanwhile, the processor 110 in the present disclosure may create the analysis data through various pre-processing methods.

According to some aspects of the present disclosure, the processor 110 may perform pre-processing by a method for combining text data included in mutually different categories of the raw data.

To be more specifically described by way of example with reference to FIG. 3, the raw data may include first text data 211 included in a reading result category 210 and second text data 221 included in a reading opinion category 220. The processor 110 may combine the first text data 211 and the second text data 221 by a method for concatenating the first text data 211 and the second text data 221 included in the reading result category 210 and the reading opinion category 220, which are mutually different categories, respectively.

When concatenating the first text data 211 and the second text data 221, the second text data 221 may be concatenated behind the first text data 211 or the first text data 211 may be concatenated behind the second text data 221. However, the present disclosure is not limited thereto.

Performing the pre-processing by the method for combining the text data included in the mutually different categories of the raw data may be determined according to a setting of a user. That is, when the user presets that the pre-processing for combining the text data included in the mutually different categories is performed, the processor 110 may combine text data 211 and 221 included in the reading result category 210 and the reading opinion category 220, respectively.

According to some aspects of the present disclosure, the processor 110 may perform the pre-processing by a method for extracting text data to be analyzed among text data included in the raw data.

Specifically, when creating the analysis data, the processor 110 may create the analysis data by extracting only text data included in any one category among text data included in the mutually different categories. In this case, the user may preset information about extraction of only text data included in a certain category.

For example, when the user presets that among the text data included in the reading result category 210 and the reading opinion category 220, only data included in the reading opinion category 220 is extracted and used, the processor 110 may extract only the second text data 221 included in the reading opinion category 220 as text data to be analyzed to create the analysis data.

For another example, when the user presets that among the text data included in the reading result category 210 and the reading opinion category 220, only data included in the reading result category 210 is extracted and used, the processor 110 may extract only the first text data 211 included in the reading result category 210 as text data to be analyzed to create the analysis data.

According to some aspects of the present disclosure, the processor 110 may perform pre-processing by a method for converting specific character data included in the raw data into preset character data.

Specifically, various special characters may be included in the raw data. However, when there are too many special characters, problems may arise when performing data structuring. Thus, the pre-processing may be performed by the method for converting the specific character data included in the raw data into the preset character data. In this case, the processor 110 may perform the pre-processing based on first information about conversion target character data and second information about conversion of the conversion target character data into which character data. The first information and the second information may be information input by the user in advance. However, the present disclosure is not limited thereto.

The present disclosure is not limited to the above-described examples of the method for performing data pre-processing described above, and various pre-processing methods may be used to perform the pre-processing.

When the analysis data is created in step S110, the processor 110 may provide at least one rule used to structure data by analyzing the analysis data using a network model (S120).

The network model may be an analysis model trained using learning data corresponding to a domain determined based on classification system information, thesaurus data, and dictionary data. That is, when the classification system information, the thesaurus data, the dictionary data, and the analysis data are input into the network model, at least one rule may be output.

According to the present disclosure, various types of natural language processing models, such as bidirectional encoder representations form transformers (BETR) models, generative pre-trained transformer (GPT) models, and text-to-text transfer transformer (T5) models, may be used as network models. However, the present disclosure is not limited thereto.

The learning data used to train the network model according to the present disclosure may be prestored in the storage unit 120.

According to some aspects, learning data belonging to various types of domain may be recorded in the storage unit 120.

In addition, the processor 110 may train the network model using the learning data corresponding to the domain determined based on the classification system information, the thesaurus data, and the dictionary data among learning data recorded in the storage unit 120. However, the present disclosure is not limited thereto.

Meanwhile, with reference to FIG. 4, the classification system information may include at least one of data 311, 321, and 331 corresponding to a plurality of hierarchically configured levels 310, 320, and 330, respectively. In this case, the classification system information may be information that is created as a manager who has expert knowledge in the corresponding domain directly inputs the at least one of data. In this case, the plurality of levels 310, 320, and 330 may be configured hierarchically.

Specifically, when the manager creates classification system information about a domain related to blood vessels, three classification systems may be created. The three classification systems are created hierarchically.

For example, the classification system for the domain related to blood vessels may be classified as Lv0 310, which is a classification system related to the highest layer, Lv2 330, which is a classification system related to the lowest layer, and Lv1 320, which is a classification system related to an intermediate layer between the Lv0 310 and the Lv2 330.

Meanwhile, the manager may create the classification system information by directly inputting information corresponding to the plurality of levels 310, 320, and 330 of the corresponding classification systems, respectively.

For example, information 311 input into the Lv0 310 may be information in which information related to a degree of stenosis is to be input into the lowest layer (Lv2 330) , information 321 input into the Lv1 320 may be information related to a name of blood vessel, and information 331 input into the Lv2 330 may be information indicating a degree of stenosis of each of blood vessels.

Consequently, the classification system information may be defined as information that is created as the manager who has expert knowledge in the domain inputs at least one data corresponding to each of a plurality of hierarchically configured levels.

Meanwhile, the thesaurus data may be data created as the manager directly inputs data having a similar meaning to at least one data included in the classification system information.

Specifically, when a doctor inputs the information indicating the degree of stenosis of blood vessels, the doctor may input data as “MINIMAL” in the same manner as predefined in the classification system information of the Lv2 330, but “MINI” may be input depending on the doctors. When data is input in a different manner from that predefined as described above, the manager may directly input the thesaurus data so that the data can be recognized as a whole.

Meanwhile, the dictionary data may be created as the manager directly inputs a lexical meaning of at least one data included in the classification system information.

Meanwhile, data included in the dictionary data may be expressed as a regular expression through a conventional method for expressing a regular expression.

For example, when there is a word “Calcified”, it may be expressed as “RE=CA[A-Z]{3,80}[D|C]” by converting the word through the conventional method for expressing a regular expression, and when there is a word “Minimal”, it may be expressed as “RE=M[A-Z]{3,7}L” by converting the word through the conventional method for expressing a regular expression. However, the present disclosure is not limited thereto.

When the dictionary data includes regular expression data, the processor 110 may easily recognize typos input by the doctor, thereby enhancing accuracy in rule creation.

Meanwhile, referring back to FIG. 2, when at least one rule is provided in step S120, a user who provides at least one rule may perform work of structuring unstructured data using at least one of the rules that the user wants.

According to the present disclosure, since at least one rule that may be used to perform the structuring work is provided to the user by automatically creating the at least one rule, the unstructured data may be structured in a short time with minimal human assistance.

FIG. 5 is a diagram for illustrating an example of at least one created rule according to some aspects of the present disclosure.

With reference to FIG. 5, at least one rule may include at least one of a rule related to a distance between keywords included in the analysis data and a rule related to an order relation between the keywords included in the analysis data.

For example, rules may be created in the network model according to the present disclosure, in which a distance between a keyword related to the name of blood vessel (for example, pRCA) and a keyword related to the degree of stenosis of blood vessels (for example, moderate) is 2, a distance between the keyword related to the name of blood vessel (for example, pRCA) and a keyword related to a plaque (for example, calcified), which is a keyword related to other information about blood vessels, is 3, and the keyword related to the degree of stenosis of blood vessels comes next to the keyword related to the name of blood vessel, followed by the keyword related to other information about blood vessels.

For another example, rules may be created in the network model according to the present disclosure, in which a distance between a keyword related to the name of blood vessel (for example, mLAD) and a keyword related to the degree of stenosis of blood vessels (for example, minimal) is 2, a distance between the keyword related to the name of blood vessel (for example, pRCA) and a keyword related to a plaque (for example, noncalcified), which is a keyword related to other information about blood vessels is 5, and the keyword related to the degree of stenosis of blood vessels is followed by the keyword related to the name of blood vessel, followed by the keyword related to other information about blood vessels.

When the rules as described above are created in the network model, at least one rule may be provided to the user. In this case, the user may use any one of at least one rule to structure the raw data.

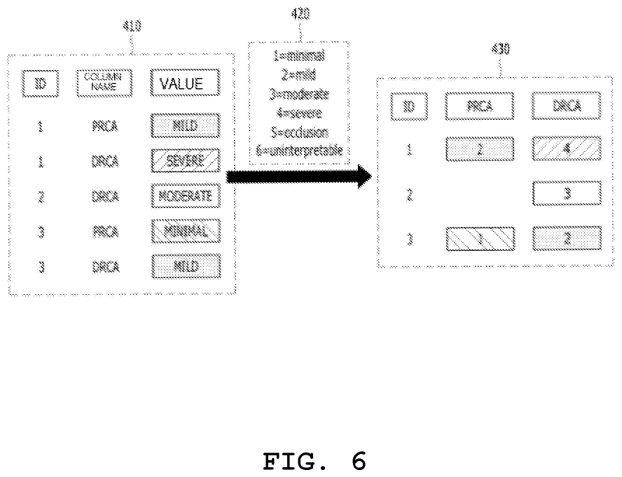

FIG. 6 is a diagram for illustrating an example of a method for post-processing data according to some aspects of the present disclosure.

According to some aspects of the present disclosure, the user may convert the unstructured data into structured data based on at least one rule (see FIG. 5) created in the network model. In this case, the structured data may be processed through post-processing.

Referring to FIG. 6, structured data 410 may be classified as an identification (ID), a column name, and a value. However, the present disclosure is not limited thereto, and the structured data 410 may have various forms.

In the present disclosure, the ID may be a value that may identify what data is related to, such as a unique number assigned to a data creator or a unique number assigned to a patient. However, the present disclosure is not limited thereto.

Meanwhile, when the information 311 related to the degree of stenosis is input into Lv0 310, a part classified as a column name may include the information related to a name of blood vessel, which is information corresponding to Lv1 320 illustrated in FIG. 4.

Meanwhile, when the information 311 related to the degree of stenosis is input into Lv0 310, a part classified as a value may include the information indicating the degree of stenosis of each of blood vessels, which is information corresponding to Lv2 330 illustrated in FIG. 4.

According to some aspects of the present disclosure, when the unstructured data is converted into the structured data 410 based on any one of at least one rule, the structured data 410 may be converted based on a predefined code table 420. In this case, the predefined code table 420 may be defined as a table in which code values are mapped to data classified as a plurality of levels in the classification system information, respectively.

For example, the predefined code table 420 may include code values that are mapped to values corresponding to Lv2 in the classification system information, respectively. However, the present disclosure is not limited thereto.

The processor 110 may convert the structured data 410 by using the information included in the predefined code table 420 to create post-processed data 430.

Meanwhile, the structured data 410 and the post-processed data 430 may have different data configurations. Specifically, when the structured data 410 and the post-processed data 430 are configured as a table, a column identifier of the structured data 410 may consist of an ID, a column name, and a value, and a column identifier of the post-processed data 430 may consist of information included in the ID and the column name of the structured data 410. That is, when the structured data 410 is post-processed, the data configuration may be changed differently.

When the post-processed data 430 is created through the post-processing, the post-processed data 430 may be recorded in the storage unit 120. When the post-processed data 430 is recorded in the storage unit 120, a search may be performed faster than when searching for the data in the future.

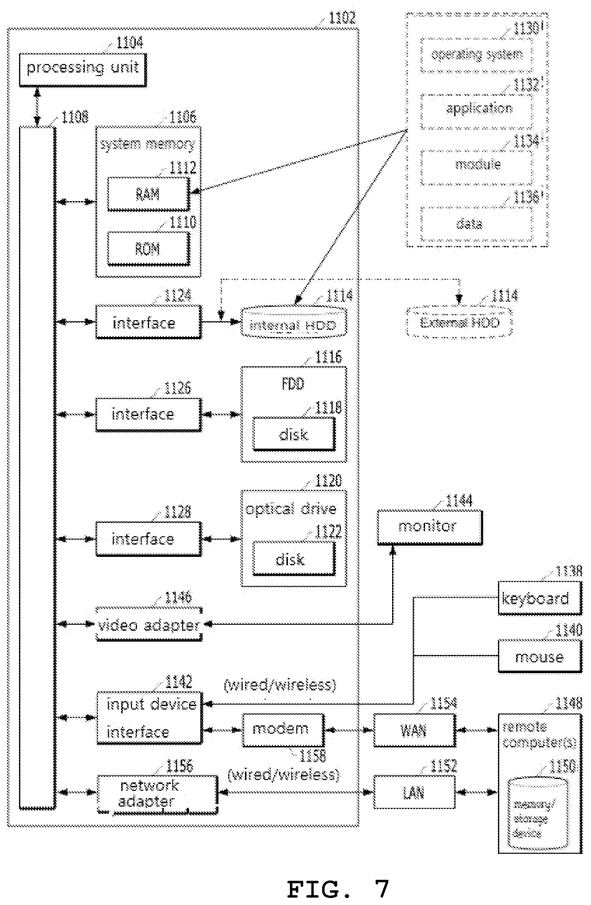

FIG. 7 is a simplified general schematic diagram for an exemplary computing environment in which aspects of the present disclosure may be implemented.

Although the present disclosure has been described above in that it can be implemented by the computing device, those skilled in the art will appreciate that the present disclosure may be implemented with computer-executable instructions that may be executed on at least one computer and/or as a combination of hardware and software and/or in combination with other program modules.

In general, program modules include routines, programs, components, data structures, etc. that may perform specific tasks or implement specific abstract data types. In addition, those skilled in the art will appreciate that the methods of the present disclosure can be implemented not only with single-processor or multiprocessor computer systems, minicomputers, and mainframe computers, but also with other computer system configurations including personal computers, handheld computing devices, microprocessor-based or programmable consumer electronics, etc. (each of which can be operated in connection with one or more associated devices).

The aspects described in the present disclosure may also be practiced in distributed computing environments where certain tasks are performed by remote processing units that are linked through a communications network. In a distributed computing environment, program modules may be located in both local and remote memory storage devices.

Computers typically include a variety of computer-readable media. Media accessible by a computer may be computer readable media regardless of the type thereof, and the media accessible by a computer may include volatile and nonvolatile media, transitory and non-transitory media, removable and non-removable media. By way of an example, but not limited thereto, computer-readable media may include computer-readable storage media and computer-readable transmission media. Computer-readable storage media include volatile and non-volatile media, temporary and non-transitory media, removable and non-removable media implemented in any method or technology for storing information such as computer readable instructions, data structures, program modules or other data. Computer-readable storage media may include, but not limited thereto, RAMS, ROMs, EEPROMs, flash memory or other memory technologies, CD-ROMs, digital video disks (DVDs) or other optical disk storage devices, magnetic cassettes, magnetic tapes, magnetic disk storage devices or other magnetic storage devices, or any other media that can be accessed by a computer and used to store desired information.

Computer readable transmission media typically implement computer readable instructions, data structures, program modules or other data in a modulated data signal such as a carrier wave or other transport mechanism, and include any information delivery medium. The term ‘modulated data signal’ refers to a signal in which one or more of the characteristics of the signal are set or changed so as to encode information in the signal. By way of an example, but not limited thereto, computer-readable transmission media include wired media such as a wired network or direct-wired connection, and wireless media such as acoustic, RF, infrared, and other wireless media. Combinations of any of the above are also intended to be included within the scope of computer-readable transmission media.

An example environment 1100 including a computer 1102 for implementing various aspects of the disclosure is shown, and the computer 1102 includes a processing unit 1104, a system memory 1106, and a system bus 1108. The system bus 1108 connects system components including (but not limited thereto) the system memory 1106 to the processing unit 1104. The processing unit 1104 may be any of a variety of commercially available processors. A dual processor and other multiprocessor architectures may also be used as the processing unit 1104.

The system bus 1108 may be any of several types of bus structures that may further be interconnected to a memory bus, a peripheral device bus, and a local bus using any of a variety of commercial bus architectures. The system memory 1106 includes a read only memory (ROM) 1110 and a random access memory (RAM) 1112. A basic input/output system (BIOS) is stored in a non-volatile memory 1110, such as a ROM, an EPROM, an EEPROM, etc., and the BIOS may include a basic routine that helps transmission of information between components within the computer 1102, such as during startup. The RAM 1112 may also include high-speed RAM, such as static RAM for caching data.

The computer 1102 may also include an internal hard disk drive (HDD) 1114 (for example, EIDE, SATA)—this internal hard disk drive 1114 may also be configured for external use within a suitable chassis (not shown)—, a magnetic floppy disk drive (FDD) 1116 (for example, for reading from or writing to removable diskette 1118), and an optical disk drive 1120 (for example, for reading from or writing to a CD-ROM disk 1122 or for reading from or writing to other high capacity optical media such as a DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. The interface 1124 for implementing the external drive may include, for example, at least one or both of Universal Serial Bus (USB) and IEEE 1394 interface technologies.

These drives and their associated computer-readable media provide non-volatile storage of data, data structures, computer-executable instructions, and the like. In the case of the computer 1102, drives and media correspond to one that stores any data in a suitable digital format. Although the computer readable storage media are described based on HDDs, removable magnetic disks, and removable optical media such as CDs or DVDs, those skilled in the art will be appreciated that other computer-readable storage media such as zip drives, magnetic cassettes, flash memory cards, cartridges, and the like may also be used in the exemplary operating environment, and any such media may include computer-executable instructions for performing the methods of the present disclosure.

A number of program modules including operating systems 1130, one or more application programs 1132, other program modules 1134, and program data 1136 may be stored in the drive and the RAM 1112. All or portions of the operating systems, applications, modules, and/or data may also be cached in the RAM 1112. It will be appreciated that the present disclosure may be implemented in various commercially available operating systems or combinations of operating systems.

A user may input commands and information into the computer 1102 via one or more wired/wireless input devices, for example, a pointing device such as a keyboard 1138 and a mouse 1140. Other input devices (not shown) may include a microphone, an IR remote controller, a joystick, a game pad, a stylus pen, a touch screen, and the like. Although these and other input devices are often connected to the processing unit 1104 through the input device interface 1142 that is connected to the system bus 1108, parallel ports, IEEE 1394 serial ports, game ports, USB ports, IR interfaces, and the like may be connected by other interfaces.

A monitor 1144 or other type of display devices is also coupled to the system bus 1108 via an interface such as a video adapter 1146. In addition to the monitor 1144, the computer generally includes other peripheral output devices (not shown) such as speakers, printers, and the like.

The computer 1102 may operate in a networked environment using logical connections to one or more remote computers such as remote computer(s) 1148 via wired and/or wireless communications. The remote computer(s) 1148 may refer to workstations, computing device computers, routers, personal computers, portable computers, microprocessor-based entertainment devices, peer devices, or other common network nodes, and may generally include many or all of the components described with respect to the computer 1102, but only the memory storage device 1150 is shown for simplicity. The logical connections shown in the drawings include wired/wireless connections to a local area network (LAN) 1152 and/or a larger network, for example, a wide area network (WAN) 1154. Such LAN and WAN networking environments are common in offices and companies, and facilitate enterprise-wide computer networks, such as intranets, and all of which can be connected to a worldwide computer network, for example, the Internet.

When used in the LAN networking environment, the computer 1102 is connected to the local network 1152 through a wired and/or wireless communication network interface or an adapter 1156. The adapter 1156 may facilitate the wired or wireless communication to the LAN 1152, which also includes a wireless access point installed therein for communicating with a wireless adapter 1156. When used in a WAN networking environment, the computer 1102 may include a modem 1158, may be connected to a communication computing device on the WAN 1154, or may include other devices for establishing communications over the WAN 1154. A modem 1158, which may be an internal or external and wired or wireless device, is coupled to the system bus 1108 via the serial port interface 1142. In a networked environment, program modules described with respect to the computer 1102 or portions thereof may be stored in a remote memory/storage device 1150. It will be appreciated that the network connections shown in the drawings are exemplary and other devices for establishing a communication link between the computers may be used.

The computer 1102 may communicate with any wireless devices or entities that are operated through wireless communication, such as printers, scanners, desktop and/or portable computers, portable data assistants (PDAs), communication satellites, and any devices or place, and phones in association with wireless detectable tags. It may include at least Wi-Fi and Bluetooth wireless technologies. Accordingly, the communication may be a predefined structure as in a conventional network or may simply be an ad hoc communication between at least two devices.

Wi-Fi (Wireless Fidelity) makes it possible to connect to the Internet, etc. without a wire. The Wi-Fi refers to a wireless technology such as cell phones that allow these devices, for example, computers, to transmit and receive data indoors and outdoors, that is, anywhere within the coverage area of a base station. The Wi-Fi networks use a radio technology called IEEE 802.11 (a, b, g, etc.) to provide safe, reliable, and high-speed wireless connections. The Wi-Fi can be used to connect computers to each other, to the Internet, and to wired networks (using IEEE 802.3 or Ethernet). The Wi-Fi networks may operate in unlicensed 2.4 and 5 GHz radio bands, for example, at 11 Mbps (802.11a) or 54 Mbps (802.11b) data rates, or in products that include both bands (dual band).

Those skilled in the art of the present disclosure will understand that information and signals may be represented using any of various different technologies and techniques. For example, data, instructions, commands, information, signals, bits, symbols, and chips that may be referenced from the above description may be expressed by voltages, currents, electromagnetic waves, magnetic fields or particles, optical field particles or particles, or any combination thereof.

A person having ordinary skill in the art of the present disclosure will recognize that various illustrative logical blocks, modules, processors, means, circuits and algorithm steps described in connection with the aspects disclosed herein may be implemented by electronic hardware (referred to as software for the purpose of convenience), various types of program, design codes, or a combination thereof. To clearly explain the interchangeability of hardware and software, various illustrative components, blocks, modules, circuits, and steps have been described above generally in terms of their functionality. Whether such functionality is implemented as hardware or software depends upon the specific application and design restrictions imposed on the overall system. A person skilled in the art of the present disclosure may implement the described functionality in various ways for each specific application, and such implementation decisions may not be interpreted as a departure from the scope of the present disclosure.

The various aspects presented herein may be implemented as methods, apparatuses, standard programming and/or articles of manufacture using engineering techniques. The term article of manufacture includes a computer program, a carrier, or media accessible from any computer-readable storage device. For example, the computer-readable storage medium includes magnetic storage devices (for example, hard disks, floppy disks, magnetic strips, etc.), optical disks (for example, CDs, DVDs, etc.), smart cards, and flash memory devices (for example, EEPROMs, cards, sticks, key drives, etc.), but it is not limited thereto. In addition, various storage media presented herein include one or more devices for storing information and/or other machine-readable media.

It is to be understood that the specific order or hierarchy of steps in the presented processes is an example of exemplary approaches. It is to be understood that the specific order or hierarchy of steps in the processes within the scope of the present disclosure may be rearranged based on design priorities. The appended method claims present elements of the various steps in a sample order, but are not limited to the presented specific order or hierarchy.

The description of the presented aspects is provided to enable any person skilled in the art to make or use the present disclosure. Various modifications to these aspects will be readily apparent to those skilled in the art, and the generic principles defined herein may be applied to other aspects without departing from the scope of the present disclosure. Thus, the present disclosure is not intended to be limited to the aspects presented herein, but is to be construed in the widest scope consistent with the principles and novel features presented herein.

What is claimed is:

1. A method for creating rules used to structure unstructured data, which is performed by a computing device including at least one processor, the method comprising:
creating analysis data by performing pre-processing on raw data; and
providing at least one rule used to perform data structuring by analyzing the analysis data using a network model.

2. The method of claim 1,
wherein the creating of the analysis data by performing the pre-processing on the raw data includes combining text data included in mutually different categories.

3. The method of claim 1, wherein the creating of the analysis data by performing the pre-processing on the raw data includes converting specific character data included in the raw data into preset character data.

4. The method of claim 1, wherein the creating of the analysis data by performing the pre-processing on the raw data includes creating the analysis data by extracting text data to be analyzed among text data included in the raw data.

5. The method of claim 1, wherein the providing of the at least one rule used to perform the data structuring by analyzing the analysis data using the network model includes:
receiving classification system information, thesaurus data, and dictionary data; and
creating the at least one rule by inputting the classification system information, the thesaurus data, the dictionary data, and the analysis data into an analysis model trained using learning data corresponding to a domain determined based on the classification system information, the thesaurus data, and the dictionary data.

6. The method of claim 5, wherein the classification system information includes information that is created as a manager who has expert knowledge in the domain inputs at least one data corresponding to each of a plurality of hierarchically configured levels,
the thesaurus data is created as the manager inputs data having a similar meaning to the at least one data included in the classification system information, and
the dictionary data is created as the manager inputs a lexical meaning of the at least one data included in the classification system information.

7. The method of claim 1, wherein the at least one rule includes at least one of a rule related to a distance between keywords included in the analysis data and a rule related to an order relation between the keywords included in the analysis data.

8. The method of claim 1, further comprising converting structured data based on a predefined code table, when the unstructured data is converted into the structured data based on any one of the at least one rule.

9. The method of claim 8, wherein the predefined code table is a table in which code values are mapped to each of data classified as a plurality of levels in classification system information.

10. A computing device that creates rules used to structure unstructured data, the computing device comprising:
a storage unit that stores a network model; and
a processor that creates analysis data by performing pre-processing on raw data,
wherein the processor provides at least one rule used to perform data structuring by analyzing the analysis data using the network model.

11. A computer program stored in a computer-readable storage medium, the computer program comprising instructions for allowing at least one processor of a computing device to perform the following steps for creating rules used to structure unstructured data, wherein the steps include:
creating analysis data by performing pre-processing on raw data; and
providing at least one rule used to perform data structuring by analyzing the analysis data using a network model.
